(19) United States
(12) Patent Application Publication
(10) Pub. No.: US 2005/0257410 A1
(43) Pub. Date: Nov. 24, 2005

(54) System for marking home utility shut-offs

(75) Inventors: Harvey R. Horowitz, Westlake, OH (US); Dennis Giza, Westlake, OH (US)

Correspondence Address: RANKIN, HILL, PORTER & CLARK, LLP, 925 EUCLID AVENUE, SUITE 700, CLEVELAND, OH, 44115-1405, US

(73) Assignee: DS & H Industries, Ltd., Westlake, OH (US)

(21) Appl. No.: 10/848,770

(22) Filed: May 19, 2004

(51) Int. Cl. G09F 3/14

(52) U.S. Cl. 40/665; 40/617

(57) ABSTRACT

A utility shutoff marking system includes a first marking sign, a second marking sign, and hangers. The first marking is sign is for mounting at the location of electrical shutoff, and has a printed indicia representing the electrical shutoff, the marking sign being made of a rugged material resistant to deterioration. The second marking sign is for mounting at the location of the main water shutoff, and also has printed indicia representing the main water shutoff, the marking sign being made of a rugged material resistant to deterioration. The hangers are for mounting the first marking sign and the second marking sign at the locations.

### FIELD OF INVENTION

The present invention relates to identifying utility shutoffs in a home or other location in the event of an emergency, and more particularly, to a system whose installation requires finding the location of such shutoffs and marking them in a prominent and relatively permanent manner.

### BACKGROUND OF THE INVENTION

Most homes are provided with a number of utilities, including electricity, natural gas and water. Each of these utilities is provided with a master shutoff so that the utility service can be disabled in the event of maintenance or emergency.

For example, in the case of water service, the water is provided to the residential home by means of a water main that connects the plumbing within the house with the water service on the street. Near the point at which the water enters the house, a main shutoff valve is usually provided, and is required by most housing codes. The plumbing within the house is usually provided with a plurality of valves elsewhere around the house, so that sections of the plumbing system can be disconnected for maintenance or repair. In order to use any of these valves, however, one must know the design of the plumbing system and know what portion of the plumbing system the valve operates. Likewise, with respect to natural gas, the natural gas is provided to the house through a gas main which connects the gas plumbing within the house with the street gas main. Again, near the point at which the gas main enters the house, there is a main gas shutoff by which all gas service to the house can be disconnected for maintenance of the gas lines within the house, or in the case of an emergency, such as a gas leak. Ordinarily, the gas main and the water main may enter the house at different locations, and the location of the main gas shutoff and the main water shutoff, need not be located near each other.

In the case of electricity, the electrical service enters the house through a cable connected to a nearby power pole or through an underground conduit. At some location within the house, a main electrical breaker is installed to allow all of the electrical service to be shut off in the case of an emergency. The house electrical system includes a number of circuits, each controlled by a breaker or fuse, and electricity in any of these circuits can be turned off by tripping the breaker or disconnecting the fuse, so that electricity can be turned off to a selected portion of the house. However, in the event of emergency, it would be necessary to know what circuit needs to be disconnected in order to disconnect the electricity to the desired location. It is often much easier and quicker in the event of an emergency to simply turn off the main breaker rather to waste valuable time determining which of the circuits to disconnect. It is also much safer to have an emergency procedure known by all persons in the house to turn of the main electrically breaker in the event of an emergency.

There should be a standard procedure known by all persons living in the house, whereby utilities can be shut off in the case of an emergency. Because of the difficulty in knowing what electrical circuits should be disconnected or which gas or water valves should be closed, it is impracticable and unsafe to attempt to shutoff only a portion of house utilities in an emergency situation. Instead, it is safer, quicker, and easier to simply disconnect the main service tot he entire house. Furthermore, it is safer and easier to remember to disconnect all utility service, regardless of the nature of the emergency. For example, if a gas leak is detected, it is naturally understood that the gas service should be disconnected, but also it is important that electrical service be disconnected to prevent any inadvertent electrical sparks that would ignite the existing gas that has already leaked.

However, due to the fact the utility shutoffs for the various utilities are located at different locations around the house, the shutoff of utilities may not be easy to locate. It is possible to draw diagrams, or otherwise inform all residents of the house where each of the utility shutoffs is located. However, this is rarely done for various reasons. One of the major reasons that it is never done is that the homeowner lacks the organization and discipline to go around the house and identify where all of the utility shutoffs are located and mark them. In addition, most homeowners do not necessarily have the ability to mark the location of the shutoffs in a easily identifiable and permanent manner.

### SUMMARY OF INVENTION

The present invention provides a unique and convenient system for identifying and marking all of the utility shutoffs in a home so that the utilities can be disconnected in the event of an emergency, quickly and safely.

In accordance with the present invention, a complete set of utility shutoff marking signs is provided, so that all of the utility shutoffs will be located and identified when the system is installed.

The system of the present invention provides a plurality of identifying signs, each of which is designed so as to permanent, so that the use of homemade signs, which can fade or deteriorate is eliminated. Furthermore, the signs are designed so as to be permanently affixed to the location of the shutoff, so that, once the signs are installed, they will remain in place to safely identify the shutoff location.

The system of the present invention provides all of the component parts necessary to identify and mark the utility shutoffs in convenient kit form, so that the completion of the installation of the kit provides the discipline required to locate all of the utility shutoffs and mark them accordingly.

Preferably, the system of the present invention may also include one or more directional signs to indicate the general direction to the marking signs, and a installation sticker or decal to be mounted near the entrance to the house to advise others, such as emergency personnel, that the utility shutoff marking system of the present invention has been installed.

These and other advantages are provided by the present invention of a utility marking system, which comprises a first marking sign, a second marking sign, and hangers. The first marking is sign is for mounting at the location of electrical shutoff, and has a printed indicia representing the electrical shutoff, the marking sign being made of a rugged material resistant to deterioration. The second marking sign is for mounting at the location of the main water shutoff, and also has printed indicia representing the main water shutoff, the marking sign being made of a rugged material resistant to deterioration. The hangers are for mounting the first marking sign and the second marking sign at the locations.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a side elevational view of the system of the present invention.

FIG. 2 is a side elevational view of the electric shutoff marking sign that comprises a portion of the system of FIG. 1.

FIG. 3 is a side elevational view of the main water shutoff marking sign that comprises another portion of the system of FIG. 1.

FIG. 4 is a side elevational view of the gas shutoff marking sign that comprises another portion of the system of FIG. 1.

FIG. 5 is a side elevational view of a blank marking sign that comprises another portion of the system of FIG. 1.

FIG. 6 is a side elevational view of a directional sign that may comprise another portion of the system of the present invention.

FIG. 7 is a side elevational view of an identification decal that may comprise another portion of the system of the present invention, and which may be displayed at the entry to the house to indicate that the system has been installed.

FIG. 8 is a perspective view of a gas shutoff with a portion of the system of the present invention installed.

FIG. 9 is a perspective view of a main water shutoff valve with a portion of the present invention installed.

FIG. 10 is a perspective view of a main electrical breaker box with a portion of the present invention installed.

### DETAILED DESCRIPTION OF PREFERRED EMBODIMENTS

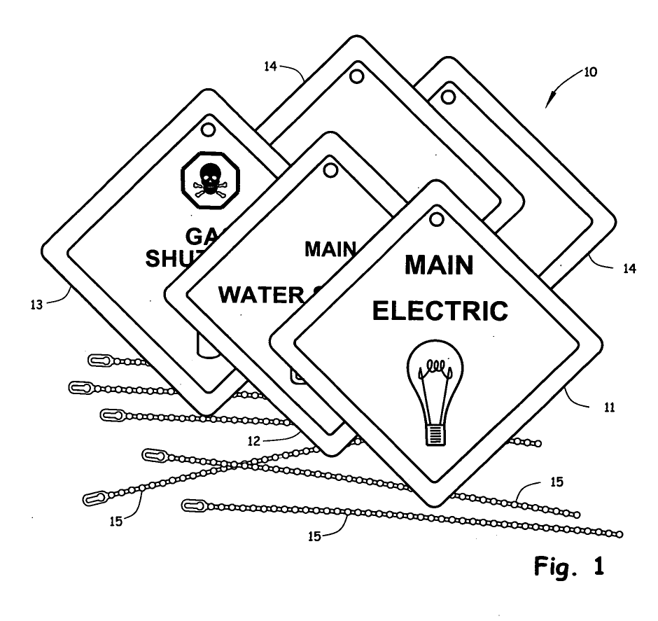

Referring more particularly to the drawings, and initially to FIG. 1, there are shown the components of the utility marking system 10 of the present invention. The system comprises a plurality of marking placards or signs 11-14 and mounting means comprising hangers 15 and/or other devices for attaching the marking signs at the location of the utility shutoffs. The components are preferably provided in the form of a kit with the signs 11-14 and the hangers 15 being provided together, preferably in a single package, so that installation of the kit requires the disciplined location of the utility shutoffs and installation of the marking signs.

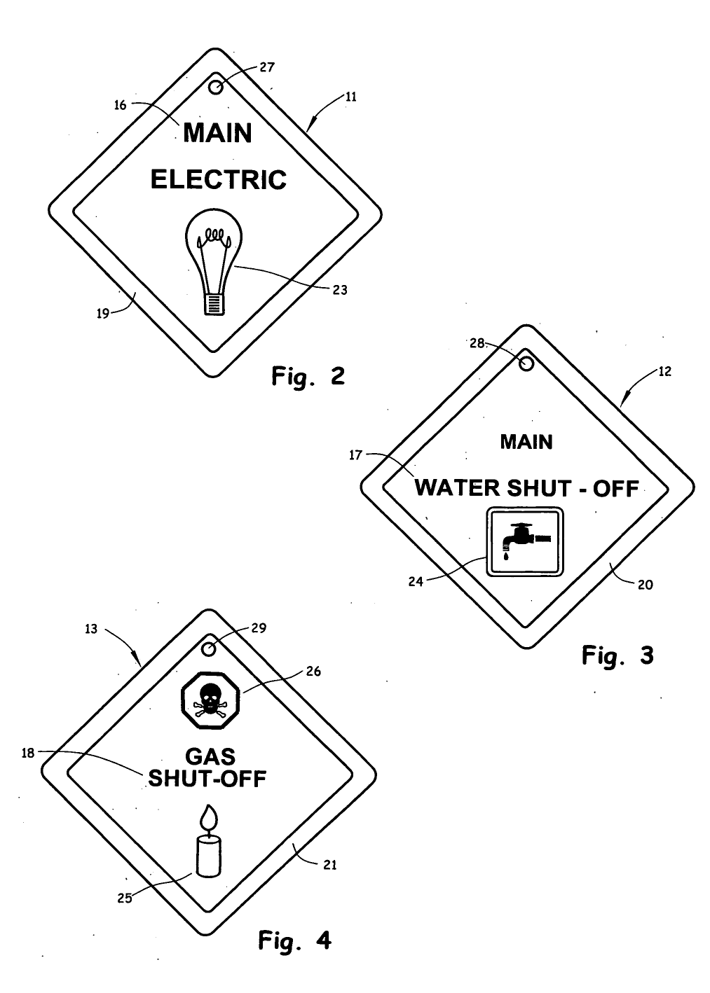

The marking signs 11-14 are shown in more detail in FIGS. 2-5. One of the marking signs 11 (FIG. 2) is used to mark the main electrical shutoff and includes on it printed indicia in the form of a worded legend 16, such as “MAIN ELECTRIC.” Another of the mark signs 12 (FIG. 3) is used to mark the main water shutoff valve and includes on it printed indicia in the form of a worded legend 17, such as “MAIN WATER SHUT-OFF.” Another of the mark signs 13 (FIG. 4) is used to mark the gas shutoff valve and includes on it printed indicia in the form of a worded legend 18, such as “GAS SHUT-OFF.”

Each of the marking signs 11-13 has a differently colored border, with the color of the border sign identifying the utility shutoff that is being marked. For example, the marking sign 11 (FIG. 2) that is used to identify the location of the main electricity shutoff or breaker preferably has a border 19 that is red, the marking sign 12 (FIG. 3) that is used to identify the main water shutoff valve gas shutoff valve has a border 20 that is blue, and the marking sign 13 (FIG. 4) that is used to identify the gas shutoff valve has a border 21 that is yellow. Bright colors are preferred for the borders, so that the signs are more easily identified in a cluttered basement or utility room, than if a neutral color were used. While having colored borders is preferred, the entire sign may be of the desired color indicating the utility whose shutoff is marked.

The colors used for the signs preferably conform to the utility marking Uniform Color Code designated by the American Public Works Association (APWA) and used by public agencies, utilities, contractors, and other groups to identify the location of subsurface utility lines and other utility lines, so that those involved in ground excavation may know the location of lines and avoid accidental damage, service interruption or injury. Using the APWA system, red is used to identify electric power lines, cables, conduit and lighting cables; yellow is used to identify gas, oil, steam, petroleum or gaseous material; orange is used to identify telephone, communication, alarm or signal lines, cables or conduit; blue is used to identify potable water; purple is used to identify reclaimed water, irrigation and slurry lines; and green is used to identify sewers and drain lines. The use of the standard APWA color designations may help emergency workers and others familiar with the system in locating the utility shutoffs more quickly in the event of an emergency.

In addition, each of the marking signs 11-13 has on it other printed indicia, in the form of a graphical symbol or icon 23-25 representing the utility which shutoff is being marked. For example, the sign 11 (FIG. 2) marking the electricity shutoff has a electric bulb icon 23, the sign 12 (FIG. 3) marking the water shutoff has a faucet and water drop icon 24, and the sign 13 (FIG. 4) marking the gas shutoff has a flame icon 25. The gas shutoff sign 13 may also include a danger or “skull and cross bones” icon 26 to indicate that leaking gas is poison, and that the gas system should be approached with caution. The graphical icons 23-25 provide for a quick identification of the marking signs 11-13, which identification is quicker than can be achieved by reading the printed sign legends 16-18, and allows the marking signs to be more quickly understood by non-English speaking persons.

Preferably, each of the marking signs 11-13 are arranged so as to be diamond shaped when hung in place at the location of the utility shutoff, so that the signs conform to the usual shape of highway warning signs in the U.S. and many other countries, and easily understood to be signs of a warning nature. To conform to the highway warning signs in other countries, a triangle shape may be used. Alternatively, any other shape can be used, although a shape other than an ordinary rectangular or square shape will make the signs more easily identifiable. Each of the marking signs 11-13 has a hole 27-29, respectively, so that the sign may be hung using the attachment means at the location of the shutoff that it is marking. Hanging signs are also preferred to signs that are mounted flat on a mounting surface, since hanging signs may move slightly in ordinary air currents, and moving signs may be more easily seen.

Each of the signs 11-13 is made so as to be rugged and not subject to deterioration, especially when mounted in basements or utility rooms which may have a damp and corrosive atmosphere. Each sign 11-13 is preferably made of a permanent plastic sheet material, such as an acrylic sheet material, 0.02 to 0.12 inches (0.5 to 3 mm) thick, and preferably about 0.06 inches (1.5 mm) thick, and is imprinted and/or embossed with the legend and indicia marking its purpose. Plastic material is preferred for the signs, since it is more permanent that other materials such as laminated cardboard, and is not likely to rust or otherwise deteriorate, such as metal. The signs may be 3 to 12 inches (75 to 300 mm) high and 3 to 12 inches (75 to 300 mm) wide, are preferably about 6 inches (150 mm) wide and 6 inches (150 mm) high, so that they are easily mounted, can be easily seen from a reasonable distance, but are not too large so as to present an obstacle in the event of an emergency.

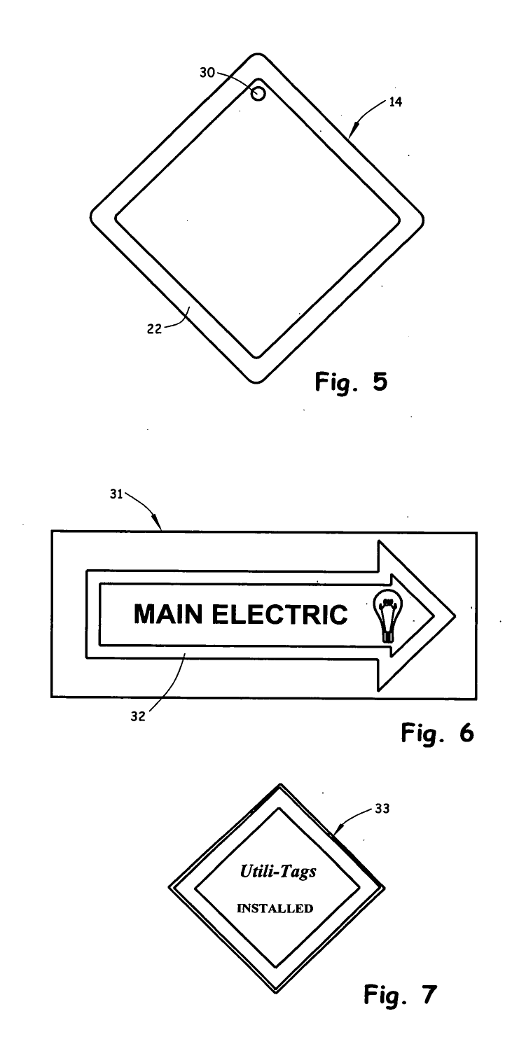

In addition to the preprinted marking signs 11-13 that identify the location of the water, gas and electrical shutoffs, the system 10 is preferably provided with one or more adaptable marking signs 14, as shown in FIG. 5 The signs 14 may be have a border 22 that is a different color than used for the signs 11-13, such as black, and may be used to mark the location of other main shutoffs or other emergency locations, such as a shutoff for a hot water heater or a shutoff for heating oil or propane gas, or an extra utility shutoff, or shutoff of telephone or cable television lines that may be provided to prevent lightening from entering the house. The sign also has a hole 30 to permit it to be hung like the other signs 11-13. The addition of the signs 14 to the system assures that all emergency utility shutoffs will be marked using the system, and that the system will not be limited to only marking the main electric, water and gas shutoffs when other important shutoffs exist.

In order to mount each of the signs at the proper location, suitable mounting means such as the hangers 15 are provided, as shown in FIG. 1. Preferably, the hangers 15 comprise plastic strips or wires or chains of the type often used to bundle wires together. Such plastic chains are well known, and comprise a flexible wire length having a plurality of spaced spherical portions, and attachment means at one end having an enlarged portion with an elongated slotted hole through which the other end of the wire length may be inserted and captured and locked as one of the spherical portions engages the slotted hole. Other suitable hangers be used, including plain metallic or plastic wire. The hangers 15 are preferably used to mount the signs by wrapping the wire around a pipe or other permanent object at the location of the utility shutoff, and permanently attaching the signs so that they will not fall down. In addition to hangers other mounting means can be used, such as permanent adhesives, tapes, clamps and the like. Adhesives and tapes may be preferred for mounting the signs to walls or electrical boxes, where a hanging sign may not be readily visible, and for this purpose, the system preferably includes mounting tape, such as double-sided adhesive foam tape, in addition to the hangers 15 described above, and the term “hangers” is intended to include any and all means by which the marking signs may be mounted at the location of the desired utility shutoff.

Since the marking signs 11-14 may not be mounted in a location that may be immediately apparent if one is looking for the signs, the system 10 may be provided with additional directional signs 31, as shown in FIG. 6. These signs 31 are preferably of different shape than the signs 11-14, and are used to direct one to the location of the marking signs rather than to mark the actual location of the utility shutoffs. For example, the directional signs 31 may be used to mark the direction to a utility room having a utility shutoff, or to smaller room within a basement, which room may not be apparent to one unfamiliar with the basement. Each of the directional signs 31 may include a directional arrow 32 having an outline of the same color as the corresponding marking sign 11-14, so that, for example, the outline of the arrow on the directional sign marking the direction to the electrical shutoff is red, which is the same color as the border of the marking sign 12. The directional signs 31 may be mounted using the same hangers 15 described above used to mount the marking signs 11-14. The directional signs 31 may also be mounted using adhesive or other suitable mounting means, since many of the directional signs will likely be mounted on vertical surfaces such as walls and doors.

Preferably, the utility shutoff marking system of the present invention also comprises one or more identification markers 33, which may be in the form of decals or stickers that the consumer may apply to doors or windows at the entrance to the house, so that emergency personnel, such as firefighters, will immediately know that the house has the utility shutoff marking system installed.

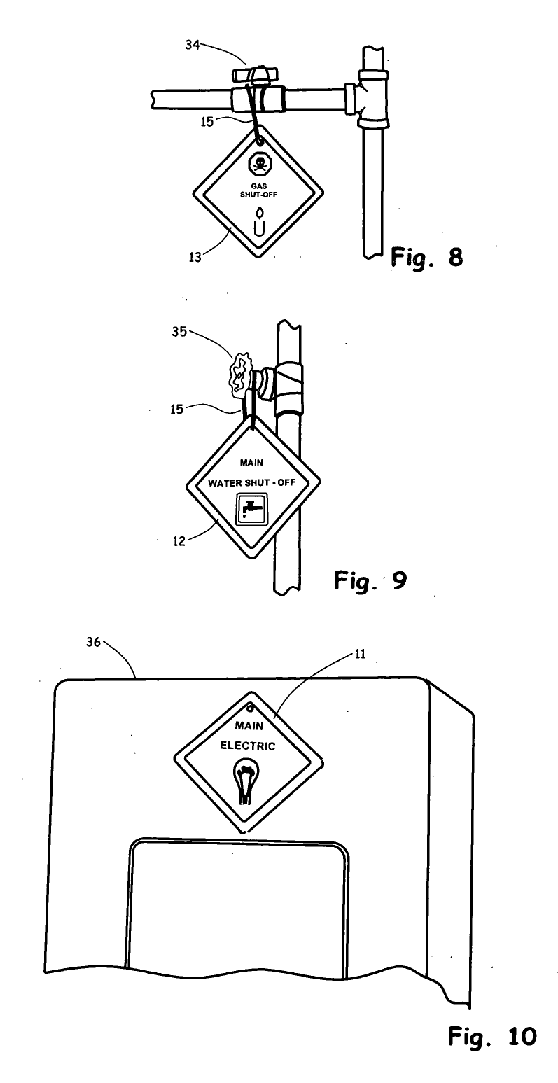

The utility shutoff marking system 10 of the present invention is used as follows. The essential elements of the utility marking system of the present invention are preferably provided in kit form, in a single package, or in a group of separate packages provided together as a unit. The consumer thus is provided with all of the essential elements of the system 10 together prior to installation, and he or she has all of the necessary elements needed to effectively mark the utility shutoffs in the house prior to beginning. Unwrapping the package, the consumer thus has at least three marking signs 11-13, one each for water, gas and electricity, and the necessary hangers 15 for each of the signs. In order to install the system 10, the consumer must identify each of the main utility shutoffs and mount each of the signs 11-13 using the hangers 15. Either by himself or herself or with the assistance of a qualified utility service person, the consumer identifies each of the main utility shutoffs. At the location of each shutoff the appropriate marking sign 11-13 is then installed. For example, at the location of the gas shutoff valve, as shown in FIG. 8, the marking sign 13 is installed by threading the plastic wire hanger 15 around the pipe at the location of the shutoff valve 34, or by threading the plastic wire hanger through a portion of the valve 34 and through the hole in the sign 13, to permanently mount the sign at the location of the valve. The other essential signs are installed in a similar manner. At the location of the main water shutoff valve 35, as shown in FIG. 9, the user threads the plastic wire hanger 15 around the pipe at the location of the shutoff valve 35 or through a portion of the valve 35 and through the hole in the sign 12. At the location of the main electrical shutoff, which may be a fuse box or breaker box 36, the user attaches the sign 11 using one of plastic wire hangers 15 or by using a different hanger arrangement in the form of adhesive tape to attach the sign to the outside of the box 36. If additional important utility shutoffs are present, the other signs 14 may be used. If any of the utility shutoffs are in a location which may not be easily discerned, the additional directional signs 31 may be installed to point to the location of the marker signs. Finally, installation identification decals 33 may be placed at the entrance locations of the house to alert emergency workers, such as firefighters, than the utility marking system 10 of the present invention has been installed in the house, so that they may have the benefit of the using the signs in the event that they need to locate the utility shutoffs in the house.

It should be realized that the embodiment described herein is only representative of the invention and is not intended to limit the invention to one particular embodiment as the invention includes all embodiments falling within the scope of the appended claims. Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1. A utility marking system, which comprises:
a first marking sign for mounting at the location of electrical shutoff, the marking sign having a printed indicia representing the electrical shutoff, the marking sign being made of a rugged material resistant to deterioration;
a second marking sign for mounting at the location of the main water shutoff, the marking sign having printed indicia representing the main water shutoff, the marking sign being made of a rugged material resistant to deterioration; and
hangers for mounting the first marking sign and the second marking sign at the locations.

2. The utility marking system of claim 1, comprising in addition a third marking sign for mounting at the location of the main gas shutoff, the marking sign having printed indicia representing the main gas shutoff, the marking sign being made of a rugged material resistant to deterioration.

3. The utility marking system of claim 1, wherein the printed indicia includes a worded legend identifying the utility shutoff being marked.

4. The utility marking system of claim 1, wherein the printed indicia includes a graphical symbolic icon identifying the utility shutoff being marked.

5. The utility marking system of claim 1, wherein each of the marking signs includes at least a portion which is colored to correspond to the utility shutoff being marked.

6. The utility marking system of claim 1, wherein each of the marking signs is diamond shaped.

7. A kit for marking utility shutoffs in a house or other similar location, which comprises:
a first marking sign for mounting at the location of electrical shutoff, the marking sign having a printed indicia representing the electrical shutoff, the marking sign being made of a rugged material resistant to deterioration;
a second marking sign for mounting at the location of the main water shutoff, the marking sign having printed indicia representing the main water shutoff, the marking sign being made of a rugged material resistant to deterioration; and
hangers for mounting the first marking sign and the second marking sign at the locations;
whereby installation of the kit assures that the electrical and water shutoffs in the house or other location are located and marked to facilitate location in the event of an emergency.

8. The kit for marking utility shutoffs of claim 7, comprising in addition a third marking sign for mounting at the location of the main gas shutoff, the marking sign having printed indicia representing the main gas shutoff, the marking sign being made of a rugged material resistant to deterioration, whereby installation of the kit assures that the gas shutoff in the house or other location is also located and marked to facilitate location in the event of an emergency.

9. The kit for marking utility shutoffs of claim 7, wherein the printed indicia includes a worded legend identifying the utility shutoff being marked.

10. The kit for marking utility shutoffs of claim 7, wherein the printed indicia includes a graphical symbolic icon identifying the utility shutoff being marked.

11. The kit for marking utility shutoffs of claim 7, wherein each of the marking signs includes at least a portion which is colored to correspond to the utility shutoff being marked.

12. The kit for marking utility shutoffs of claim 7, wherein each of the marking signs is diamond shaped.

13. A method for marking the location of utility shutoffs in a house or other similar location, comprising the steps of:
obtaining a kit comprising a plurality of marking signs and a plurality of hangers, each marking sign having a printed indicia representing the shutoff to be marked, each marking sign being made of a rugged material resistant to deterioration;
locating the electrical shutoff in the house or other location;
mounting one of the marking signs from the kit using one of the hangers at the location of the electrical shutoff;
locating the main water shutoff in the house or other location; and
mounting another of the marking signs from the kit using one of the hangers at the location of the main water shutoff.

14. The method for marking the location of utility shutoffs of claim 13, comprising the additional steps of:
locating the gas shutoff in the house or other location; and
mounting another of the marking signs from the kit using one of the hangers at the location of the gas shutoff.

15. The method for marking the location of utility shutoffs of claim 13, comprising the additional step of mounting an indication near an entrance to the house or other location after all of the marking signs have been mounted to indicate that the existence of the mounted marking signs.

16. The method for marking the location of utility shutoffs of claim 13, comprising the additional step of mounting a directional sign to indicate the direction to the location of one of the marking signs.
